(19) United States
(12) Patent Application Publication
(10) Pub. No.: US 2005/0086635 A1
(43) Pub. Date: Apr. 21, 2005

(54) Visual programming system and method

(75) Inventors: Neel J. Parikh, Richmond Heights, OH (US); Sivashanmugam Alagarsamy, Willoughby, OH (US); Philip A. Weintz, Chardon, OH (US)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Pegasus Technologies, Inc.

(21) Appl. No.: 10/689,276

(22) Filed: Oct. 20, 2003

(51) Int. Cl. G06F 9/44

(52) U.S. Cl. 717/103

(57) ABSTRACT

A visual programming system and method for defining application specific processing logic for various applications. The present invention provides a graphical user interface for selecting components, linking the components to form logic strings that define a control flow sequence. At least one of source code, executable code and a dynamically linked library (DLL) is generated from the control flow sequence. The present invention finds utility in connection with a control system for an electricity generating power plant.

### FIELD OF THE INVENTION

The present invention relates generally to the field of information processing, and more particularly to a visual programming system and method.

### BACKGROUND OF THE INVENTION

A wide variety of complex applications require custom processing logic. For instance, process measurement, monitoring and improvement applications interacting with control systems for electricity generating power plants require custom processing logic, since each electricity generating power plant has a unique design. Typically, custom processing logic for such applications has been implemented by directly generating program code in a conventional text-based programming language, such as C, C++ or FORTRAN to provide executable code or a dynamically linked library (DLL). Accordingly, power plant field engineers have had to rely upon the skills of computer programmers to implement custom processing logic.

The present invention overcomes these and other problems, to provide a visual programming system and method for implementing custom processing logic.

### SUMMARY OF THE INVENTION

In accordance with the present invention, there is provided a visual programming system for generating custom processing logic, the system comprising: (a) means for selecting components from a group of components, wherein each component has associated properties, each selected component displayed in a design region; (b) means for defining the properties associated with each selected component; (c) means for linking the selected components to form one or more logic strings, said logic strings defining a control flow sequence; (d) means for generating from said control flow sequence at least one of: source code, executable code and a dynamically linked library (DLL); and (e) a global data store for storing data associated with each component of the control flow sequence, wherein each component of the control flow sequence shares their respective data with the other components through the global data store.

In accordance with another aspect of the present invention, there is provided a visual programming method for generating custom processing logic. The method includes the steps of: (a) selecting components from a group of components, wherein each component has associated properties, each selected component displayed in a design region; (b) defining the properties associated with each selected component, wherein data associated with each component of the control flow sequence is stored in a global data store, each component of the control flow sequence sharing their respective data with the other components through the global data store; (c) linking the selected components to form one or more logic strings, said logic strings defining a control flow sequence; and (d) generating from said control flow sequence at least one of: source code, executable code and a dynamically linked library (DLL).

In accordance with still another aspect of the present invention, there is provided a control system for an electricity generating power plant, comprising: (1) a central control system (as defined herein); (2) a plurality of sensing devices for sensing operating conditions and parameters associated with the power plant; (3) an optimization computer system for optimizing at least one power plant process; and (4) a visual programming system for programming the optimization computer system, said visual programming system comprising: (a) means for selecting components from a group of components, wherein each component has associated properties, each selected component displayed in a design region, (b) means for defining the properties associated with each selected component, (c) means for linking the selected components to form one or more logic strings, said logic strings defining a control flow sequence, (d) means for generating from said control flow sequence at least one of: source code, executable code and a dynamically linked library (DLL), and (e) a global data store for storing data associated with each component of the control flow sequence, wherein each component of the control flow sequence shares their respective data with the other components through the global data store.

An advantage of the present invention is the provision of a visual programming system and method that provides a simple user-friendly graphical interface for generating custom processing logic.

Another advantage of the present invention is the provision of a visual programming system and method that eliminates the need to directly code in a text-based programming language.

Still another advantage of the present invention is the provision of a visual programming system and method that generates processing logic in the form of at least one of: source code, executable code and a dynamically linked library (DLL).

Still another advantage of the present invention is the provision of a visual programming system and method that incorporates notification logic.

A still further advantage of the present invention is the provision of a visual programming system and method that can bi-directionally exchange information with one or more data sources for the purposes of advisory or closed-loop supervisory control and performance monitoring.

Yet another advantage of the present invention is the provision of a visual programming system and method that finds utility in connection with control systems for electricity generating power plants.

These and other advantages will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a flow diagram of a visual programming method, according to a preferred embodiment of the present invention;

FIG. 2 illustrates a graphical user interface, according to a preferred embodiment of the present invention;

FIG. 3 is a block diagram showing a global data store;

FIG. 4 shows Pseudo Code for the generation of C++ code by examining a control flow sequence;

FIG. 5 illustrates an exemplary control flow sequence comprised of a Start component, a Check IF component, and first and second Arithmetic components;

FIG. 6 is a block diagram of an exemplary power plant control system;

FIG. 7 illustrates a property window for defining the properties associated with a Start component;

FIG. 8 illustrates a property window for defining the properties associated with a Check Status component;

FIG. 9 illustrates a property window for defining the properties associated with a Constants component;

FIG. 10 illustrates a property window for defining the properties associated with an Arithmetic component;

FIG. 11 illustrates a property window for defining the properties associated with a Number Array component;

FIG. 12 illustrates a property window for defining the properties associated with a Bitop component;

FIG. 13 illustrates a property window for defining the properties associated with a For Loop component;

FIG. 14 illustrates a property window for defining the properties associated with a Clip component;

FIG. 15 illustrates a property window for defining the properties associated with a CallSub component;

FIG. 16 illustrates a property window for defining the properties associated with a SubStart component;

FIG. 17 illustrates a property window for defining the properties associated with a Date Time component;

FIG. 18 illustrates a property window for defining the properties associated with a User Defined Function component;

FIG. 19 illustrates a property window for defining the properties associated with a Log Writer component;

FIG. 20 illustrates a property window for defining the properties associated with an Applis function component;

FIG. 21 illustrates a property window for defining the properties associated with an Attneuate function component;

FIG. 22 illustrates a property window for defining the properties associated with an Bound function component;

FIG. 23 illustrates a property window for defining the properties associated with a GetValue Function;

FIG. 24 illustrates a property window for defining the properties associated with a GetQuality Function;

FIG. 25 illustrates a property window for defining the properties associated with a SetReturnValue Function;

FIG. 26 illustrates a property window for defining the properties associated with a SetReturnQuality Function; and

FIG. 27 is a flow diagram illustrating the use of a DLL generated by the visual programming system in connection with a Sequential Optimizer application.

### DETAILED DESCRIPTION OF A PREFERRED EMBODIMENT

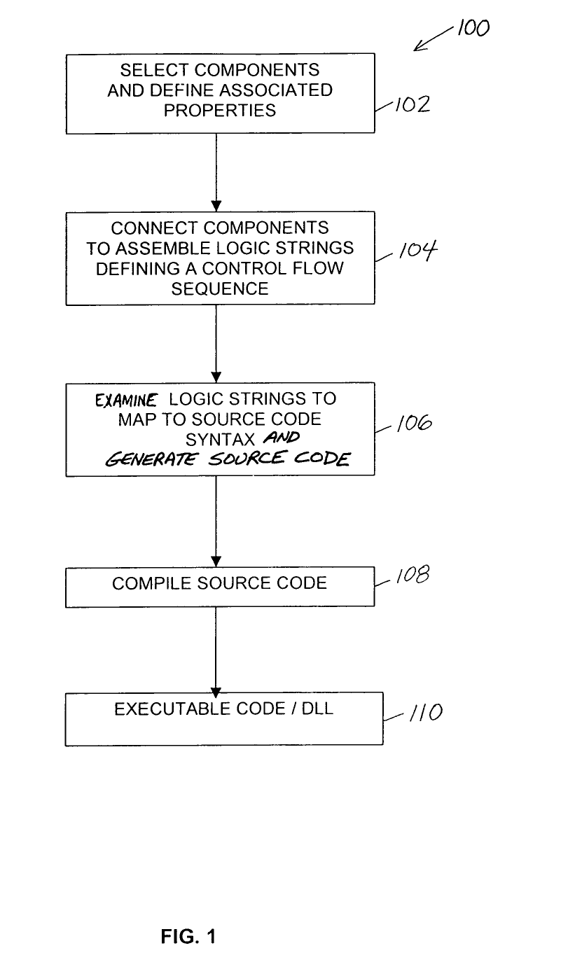

Referring now to the drawings wherein the showings are for the purposes of illustrating a preferred embodiment of the invention only and not for purposes of limiting same, FIG. 1 shows a flow chart 100 illustrating basic operation of the visual programming system for generating custom processing logic, according to a preferred embodiment of the present invention. A user selects components and defines the properties associated with each component (step 102). Components define arithmetic, logical or function call operations, as will be described in detail below. Each component has an associated set of properties. The components are linked or connected to form one or more logic strings defining a control flow sequence (step 104). The components are connected in the order in which the processing logic flows. At step 106, the logic strings are examined to: (a) map the data associated with each component to a source code syntax (e.g., C, C++ or FORTRAN), and (b) generate the source code. Next, the source code is compiled using a standard compiler (step 108) to generate executable code, or a dynamically linked library (DLL), that is made available for use by an application. Steps 102 and 104 are carried out using a graphical user interface, as will be described in detail below.

It should be understood that the visual programming system of the present invention can bi-directionally exchange information with one or more data sources. In this regard, the executable code generated by the visual programming system may be utilized to interface with data sources. The DLL generated by the visual programming system may alternatively be utilized by the executable code, which in turn interfaces with the data sources. In addition, the executable code generated by the visual programming system may be utilized to interface with a reference database, which in turn interfaces with the data sources. Furthermore, the DLL generated by the visual programming system may be utilized by executable code which interfaces with a reference database, which in turn interfaces with data sources.

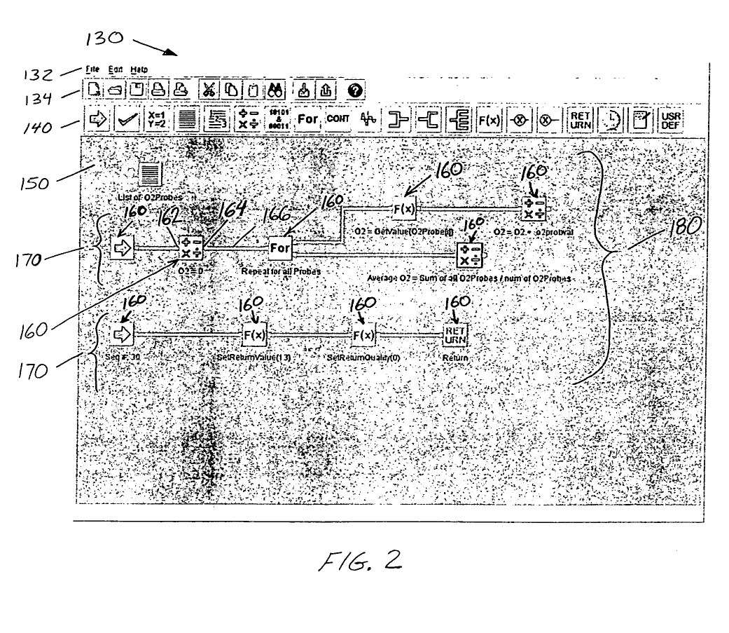

FIG. 2 illustrates a graphical user interface 130, according to a preferred embodiment of the present invention. Graphical user interface 130 includes a conventional menu option list 132, a conventional toolbar 134, a component selection list 136, and a design space 150. Toolbar 134 includes such standard operations as FILE LOAD, FILE SAVE, CUT, COPY, PASTE, PRINT, FIND, PRINT, and the like. Component selection list 140 provides a plurality of icons representative of a component. In the illustrated embodiment, the components include, but are not limited to: Start, CheckStatus, Constants, Arithmetic, Number Array, Binary Operations, For Loop, Clip, Multiplexer, Distributor, Call Subroutine, Subroutine Start, Continue With Loop, Return, Date Time, User Defined, Log Writer, and Function. Each of these components is described in detail below. Design space 150 is a display region wherein a plurality of components 160 are arranged and connected to form logic strings 170. As indicated above, logic strings 170 define a control flow sequence 180. In the illustrated embodiment, components 160 are linked by inserting connecting lines 166 between components 160.

Each component may have one or more input ports 162, or one or more output ports 164, or both. Input and output ports 162, 164 are used to pass control between components. In this regard, when processing enters an input port, the component performs its defined task, and then when required, passes control to a successor component in the control flow sequence. It should be understood that components that have neither an input port 162 nor an output port 164 are used to define data in a global data store described in detail below.

In a preferred embodiment of the present invention, user-defined comments may be added to design area 150 to explain the processing logic. A comment may take the form of multiple lines of text, and can include HTML tags for formatting. For example, <FONT COLOR=“#FF000”> COMMENT IN RED </FONT> will appear as red colored text “COMMENT IN RED.”

A property window is provided to enter properties associated with a respective component, as will be described in detail below. In the illustrated embodiment, a property window associated with a component is displayed when “double clicking” on the component. It should be understood that each component has a defined name. A name is associated with a component by entering the name in the “name field” of a property window associated with the component.

FIG. 7 illustrates a property window for defining the properties (i.e., a routine type and a sequence number) associated with a Start component. The Start component is the first component to be executed in a control flow sequence. When there are multiple Start components in a control flow sequence, the sequence number of the Start component determines the order in which the flow logic is processed. In this regard, start components with the lowest sequence number are processed first. Multiple routines may be supported by a DLL. When configuring a control flow sequence for such a DLL, the routine for which the logic stream is configured is identified in the “routine type” field.

FIG. 8 illustrates a property window for defining the properties associated with a Check Status component. The Check Status component is also referred to herein as the “Check IF” component, since it performs IF/THEN conditional logic. The Check Status component performs conditional logic using a defined set of checks (e.g., equal, not equal, greater than, less than, etc.) on a list of parameters. When a true condition occurs as a result of the checks, the process flow continues out through the top output port of the component. Otherwise, the process flow continues out through the bottom output port. The Check Status component can be used to define a list of checks and the true condition can be triggered when all or at least one of them is true. This is set by the property called “AND or OR.” In the illustrated embodiment, a comparison is accomplished by using the various pull down menus within the box labeled “Check.” The buttons identified as “Add Check,” “Set Check,” and “Remove Check” are used to manipulate the list of comparisons.

FIG. 9 illustrates a property window for defining the properties (i.e., variable name and variable value) associated with a Constants component. The Constants component is used to define and initialize a list of constants and variables for a control flow sequence. The constants and variables are initialized once upon startup of processing. A list of configurable variables within a single design component, allows for ease of design maintenance. The property window for the Constant component is used to add, remove, or edit a constant in a list. In this regard, the buttons identified as “Set Variable” and “Remove Variable” are used to manipulate the list of constants.

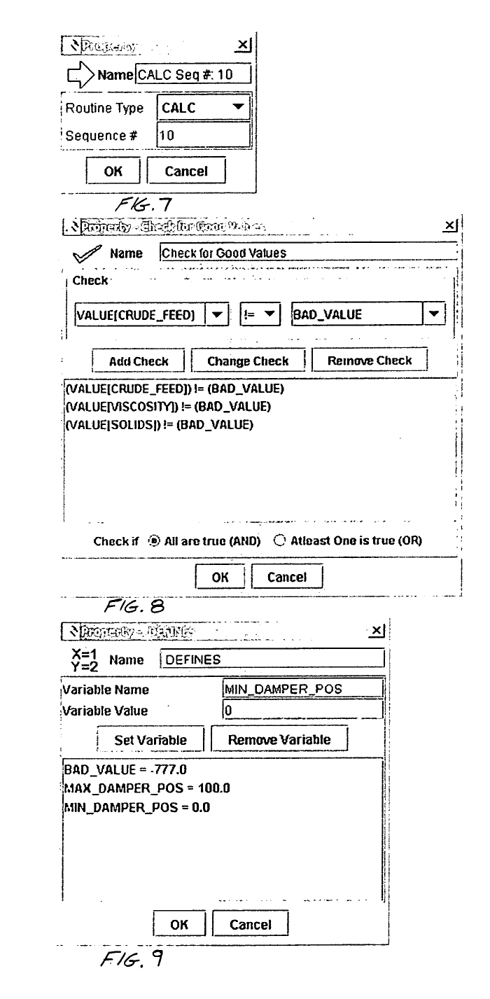

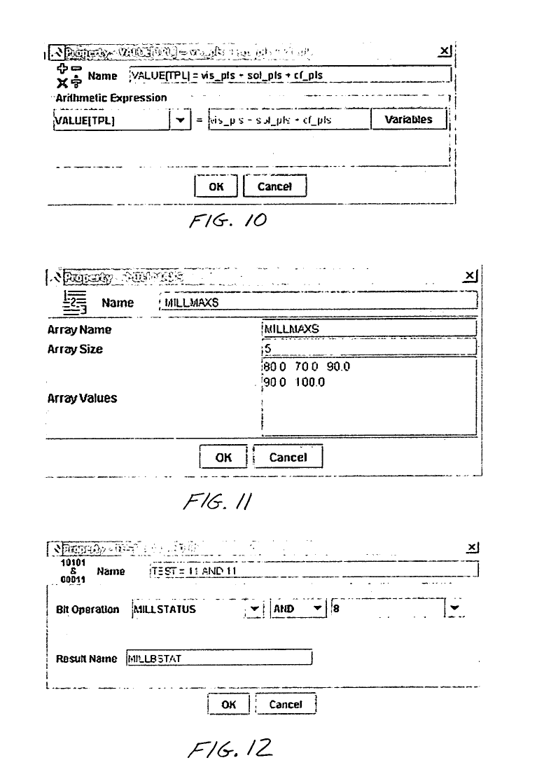

FIG. 10 illustrates a property window for defining the properties associated with an Arithmetic component. The Arithmetic component is used to evaluate a mathematical equation. The mathematical equation may be comprised of variables and constants. Variables may be selected from “result names” identified by a component earlier in the control flow sequence. The result of a mathematical equation is stored in a user-defined variable. The “result name” is then made available for use by other components in the control flow sequence. The mathematical equation is entered in the “arithmetic expression” field. The button labeled “variables” is used to select a variable from the list of available variables and add it to the mathematical equation.

FIG. 11 illustrates a property window for defining the properties (i.e., array name, size and values) associated with a Number Array component. The Number Array component is used to create an array of numbers. In this regard, a single reference is defined to access the list. One typical use of a numeric array is to create a set of parameters to be used within the processing of a “FOR” loop. Every individual value in the array can be referred to by the array's name and a subscript. For example, if MILLMAXS is an array name which has a set of numbers {80, 70, 90, 100} then MILLMAXS[0] refers to 80, MILLMAXS[1] refers to 70 and so on. An “array name” field is used to make the array available to other components. Array values are provided in an “array values” field. The number of array elements is calculated and stored in an “array size” field.

FIG. 12 illustrates a property window for defining the properties (i.e., bit operation and result name) associated with a Bitop component. The Bitop component is used for performing bit manipulations on a variable. The bit operations, include, but are not limited to, AND, OR, Right Shift, and Left Shift. Operands and a binary command are entered in the appropriate fields to define a bit operation. The result of the bit operation is stored as a user-defined “result name,” and is made available for use by other components in the control flow sequence.

FIG. 13 illustrates a property window for defining the properties (i.e., index name and repeat count) associated with a For Loop component. The For Loop component is used to repeat a portion of the control flow sequence for a given number of times. This component includes two output ports, namely, the loop port (top output port) and the continue port (bottom output port). The loop port is connected to the portion of the control flow sequence that is to be repeated. The continue port is the port where the control flow sequence will continue after repetitions are completed. The For Loop component has an index variable that is incremented with every iteration. The index value starts at 1 and increases by one thereafter. If the For Loop component is configured to repeat 3 times, the index variable will have a value of 1, 2 and 3 through the iterations. The index variable can be used as a subscript for accessing an array. As part of the loop logic it is possible to pass a parameter or a number array name to define the number of iterations. If an array is passed, the array size defines the number of iterations to be performed. The For Loop component can also pass a count for the number of iterations. A variable name is entered into an “index name” field. The “repeat count” is defined by selecting either “count” or “size of array”. If “count” is selected then the number of times the loop is to repeat is entered. If “size of array” is selected, the name of array to be used is entered.

FIG. 14 illustrates a property window for defining the properties (i.e., parameter name, lower threshold, and upper threshold) associated with a Clip component. The Clip component is used to perform out-of-range condition checks on a given variable, and consequently to limit the value of the variable to be contained within that range. Whenever the value of the variable is found to be outside of these limits it is reset in the following manner. If the value is above an “upper threshold” then it is set to the maximum value. Likewise, if it is below the “lower threshold” it is set to the minimum value. If found to be within the range, no changes are made to the variable. A parameter name of the variable to be monitored is entered into a “parameter name” field. Minimum and maximum values are respectively entered in the “lower threshold” and “upper threshold” fields.

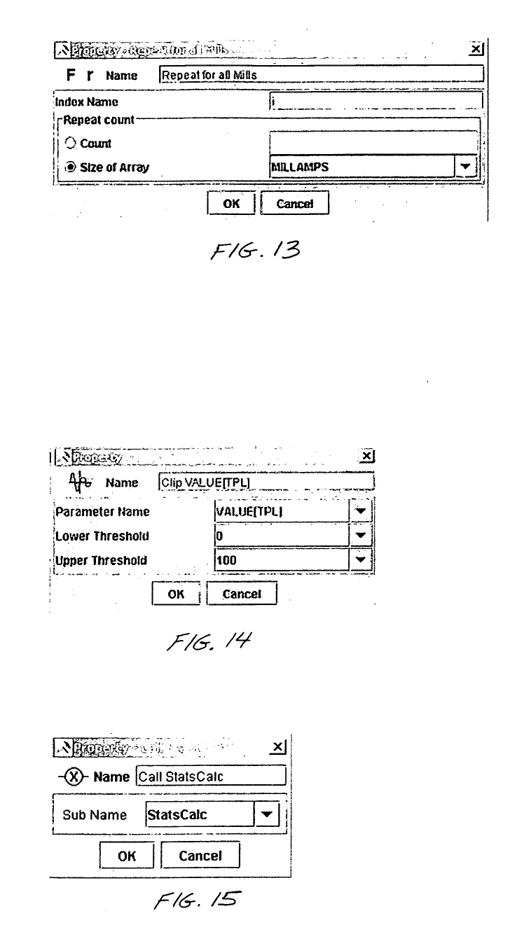

FIG. 15 illustrates a property window for defining the properties (i.e., Sub Name) associated with a CallSub component, and FIG. 16 illustrates a property window for defining the properties (i.e., Sub Name) associated with a SubStart component. A CallSub component is used in connection with a SubStart component. In this regard, the CallSub component calls processing logic defined with a SubStart component. If a piece of processing logic needs to be used at multiple places, it is preferable to define it as a subroutine, and call it from multiple places. The CallSub and SubStart components are tied together with a common label name.

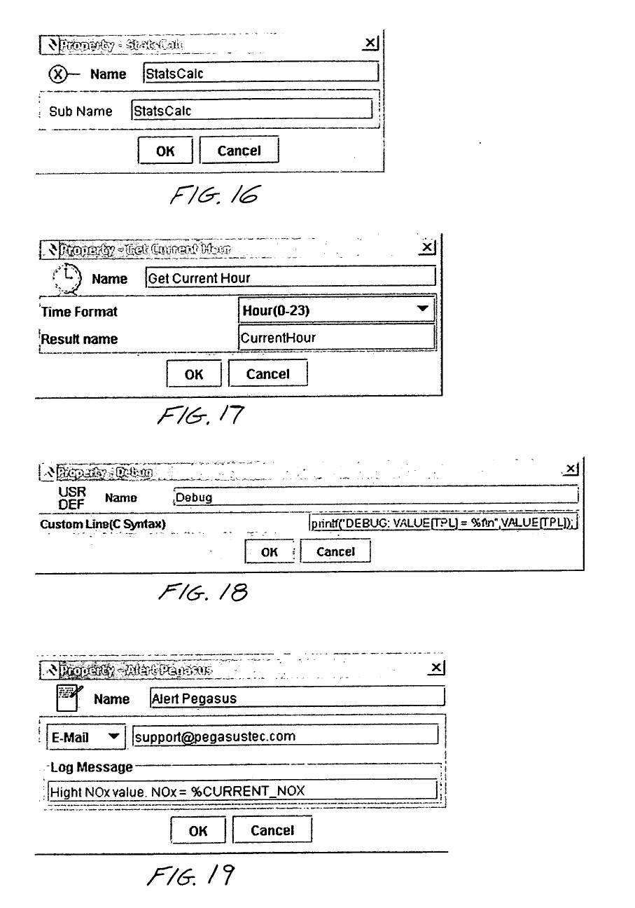

FIG. 17 illustrates a property window for defining the properties (i.e., Time Format and Result Name) associated with a Date Time component. The Date Time component provides the current date or time available in several formats. The different formats to choose from include, but are not limited to: the number of seconds since Jan. 1, 1970 UTC, the current hour, current minute, current seconds, the numeric month, day, or year. The format is selected by entering the format into the “time format” field. The variable name in which the result is to be stored is entered into a “result name” field. The variable name entered in the “result name” field is available for use by other components in the control flow sequence.

FIG. 18 illustrates a property window for defining the properties (i.e., Custom Line Syntax) associated with a User Defined Function component. The User Defined Function component allows a user to add custom text-based programming code (e.g., C, C++, FORTRAN, etc.) into a control flow sequence. Accordingly, a user can include a call to custom program code functions (e.g., C, C++, and FORTRAN functions) or have a one line code in the control flow sequence. A “custom line” field is provided for entry of the code.

FIG. 19 illustrates a property window for defining the properties (i.e., Log Type and Log Message) associated with a Log Writer component. This component finds advantageous use for debugging purposes, event notification, sending alerts, monitoring and diagnostics. The Log Writer component allows messages to be written to the selected “log type.” In the illustrated embodiment, the “log type” can be chosen from a pull down menu that presents several options, including, but not limited to writing to one or more email addresses, a console, or a file. The message could include a variable's value used in a control flow sequence. If the properties of the Log Writer component are customized to write to a file, the message is written to a specified file identified by entering a filename into a “filename” text field. A log message is entered into a “log message” field. If the E-Mail option is selected, the log message is emailed to one or more email ids selected from the list specified in the properties. The “filename” text field alternatively be used to identify one or more file attachments to be included with an email message.

A Multiplex component merges two event flows into a single process flow. The multiplex component has two input ports and one output port (i.e., a top input port and a bottom input port). When two separate branches in the event flow are to perform the same processing steps, they can be combined into a single path.

A Distributor component serves as a connector to process multiple processing event flow. The distributor component has one input port and multiple output ports (i.e., a top output port and one or more additional output ports). The path connected to the top output port will be executed first. When that path is completed, the event trigger will be sent to the next output port. The order of processing flows from top to bottom ports.

A ContinueWithLoop component stops the current iteration and continues with the next iteration of a “For Loop.”

A Return component is used to return from the logic without proceeding further. When a Return component is encountered in a logic flow, the control returns from the logic.

It should be appreciated that a Function component is customizable for specialized applications of the visual programming system, as will be described in detail below. In this regard, the Function component may provide a specific function that the user can call in the control flow sequence, as will be described in further detail below.

In accordance with a preferred embodiment of the present invention, each component in a control flow sequence shares their respective data through a global data store 190 that acts as a data registry (see FIG. 3). In this manner, each component can access data from other components for its processing. Global data store 190 stores a plurality of data objects 192. Each data object 192 has an associated “data type,” “data name” and “reference count” field. When a component is added to design area 150, the component creates a data object in global data store 190 for storing data associated with the component. In a preferred embodiment, global data store 190 supports number, number array, string, and string array data types.

Components refer to data objects stored in global data store 190 using data name and data type identifiers that are stored in respective fields. The number of components referring to a data object is maintained in the “reference count” field. When a component that has a reference to a data object is deleted from the control flow sequence in design area 150, the reference count to the data object is decremented. When the reference count becomes zero, the data object is deleted from global data store 190. It should be appreciated that no “data flow” connections are needed between components in design area 150, because each component can directly refer to a data object in global data store 190. Consequently, the display of the control flow sequence in design area 150 is simplified.

As indicated above, a set of components are assembled to define processing logic in the form of at least one: source code, executable code and a dynamically linked library (DLL). The connections between the components define logic strings. In accordance with a preferred embodiment of the present invention, components are connected by clicking on the output port of a first component and dragging the mouse to the input port of a second component. A logic string of connected components defines a control flow sequence to be performed to accomplish a task. Each logic string begins with a Start component. As noted above, each Start component has a sequence number that determines the sequence in which multiple logic strings are executed.

The visual programming system of the present invention also provides various consistency and error checks during different stages of the visual programming process. When a component is added to design area 150, the component is displayed in a first color if the properties associated with the component need to be set for it to be valid. Once the properties are validly set, the component color changes from the first color to a second color. Checks are also performed while adding, deleting or changing the properties of a component. If an error is detected in a component property, the component is highlighted (e.g., by use of an alternative color). Moreover, a user is prevented from entering improper data in component property fields.

It should be appreciated that the control flow process as represented by the components 160 and connecting lines 166, and any additional comments placed in design space 150, may be saved to a configuration file and loaded later. The configuration file will store the properties associated with each component. When a design is loaded, the properties stored in the configuration file are parsed and used to recreate components 160.

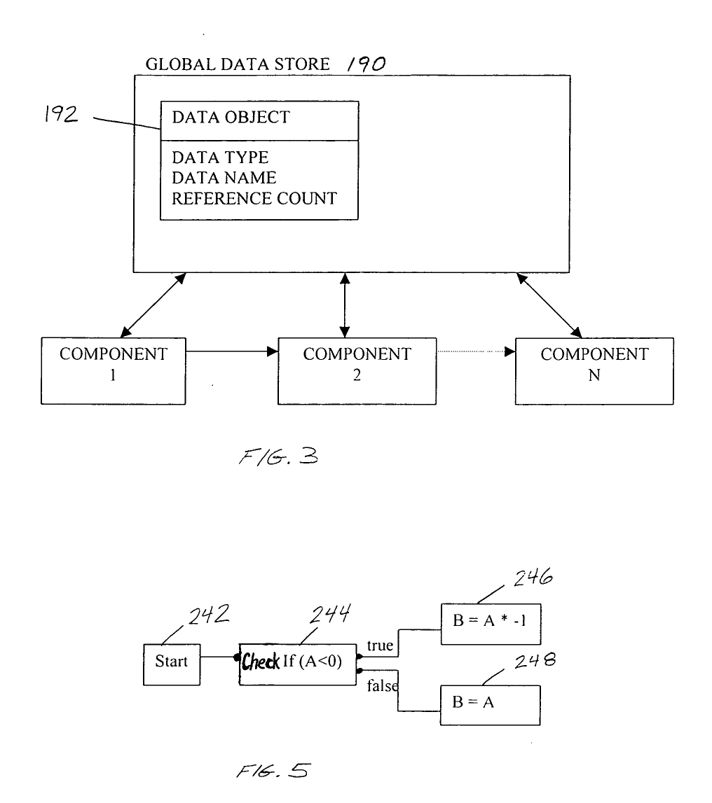

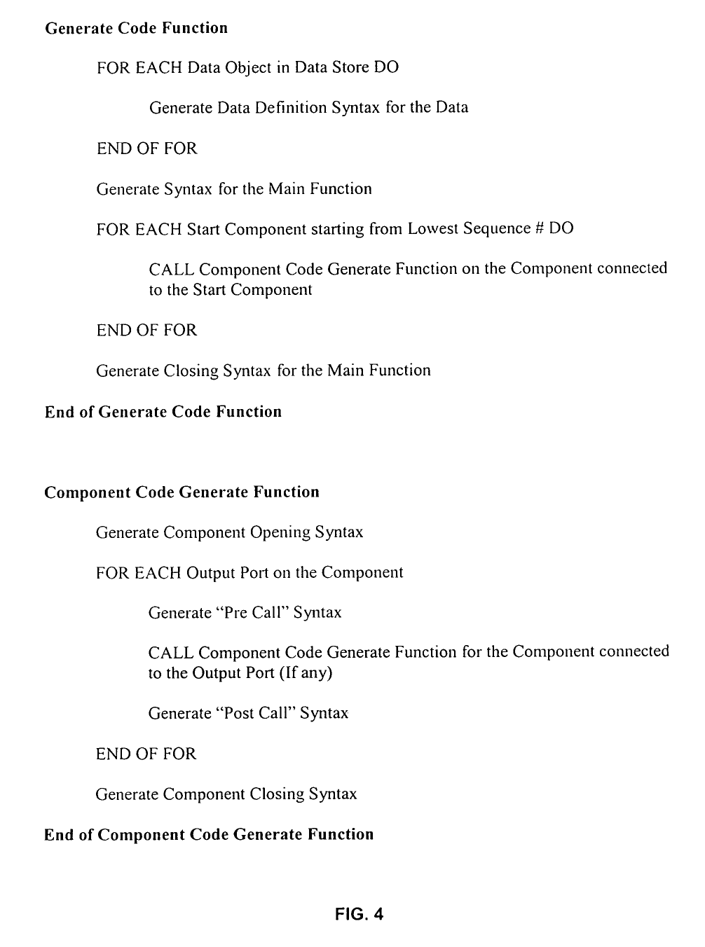

Generation of source code syntax (i.e., step 106 of FIG. 1) will now be described in detail with reference to FIG. 4 and FIG. 5. FIG. 4 is Pseudo Code for generating C++ code by examining a control flow sequence. It should be appreciated that similar Pseudo Code would apply to generation of code for other programming languages.

FIG. 5 illustrates an exemplary control flow sequence comprised of a Start component 242, a Check IF component 244, a first Arithmetic component 246, and second Arithmetic component 248. In the illustrated embodiment, the source code syntax is C++. If the visual programming system is configured to generate a DLL, the “main function” is the Function that is exported for other applications to call. If the visual programming system is configured to generate an executable file, the main Function is “int main( )” which is used in C++ syntax to define the first called function when a program is started. It should be appreciated that C++ source code is exemplary, and that it is contemplated that other programming languages may be used in connection with the present invention.

The completed source code syntax for the control flow sequence shown in FIG. 5 is listed below:

```
double A;
double B;
Int main( )
{
  LABEL10:
      If(A<0)
      {
        B = A * −1;
      }
      else
      {
        B = A;
      }
  }
```

Since the control flow sequence includes variables A and B, these two variables are found in the global data store. Accordingly, control is passed to the global data store to generate the data definition for these two variables.
double A;
double B;

The Opening syntax for the main function is then generated.
Int main( )
{

Control then passes to the Start component to generate a C label with the sequence number.
LABEL10.

Control then passes to the Check IF component that is connected to the Start component. The Check IF component generates the opening syntax.
if(A<0)

For the logic “true” output port, a Pre Call Syntax is generated.
{

Control then passes to the next component in the chain connected to the logic “true” output port of the Check IF component (i.e., the first Arithmetic component). The first Arithmetic component generates code.
B=A*−1
;

The call returns from the first Arithmetic component back to the Check IF component. The Check IF component generates the Post Call syntax for the logic “true” output port.
}

The Check IF component generates the “Pre Call” syntax for the logic “false” output port.
else
{

Control then passes to the next component in the chain connected to the logic “false” output port of the Check IF component (i.e., the second Arithmetic component). The second Arithmetic component generates code.
B=A;

The call returns from the second Arithmetic component back to the Check IF component. The Check IF component generates the Post Call syntax for the logic “false” output port.
}

The Check IF component does not have any closing syntax, so it passes control back to the Start component. The Start component does not have any closing syntax, so closing syntax for the main function is generated.
}

The visual programming system of the present invention may be implemented on a wide variety of computer systems, including, but not limited to, a conventional Intel-Windows based personal computer system (PC), a SUN computer system, and other computer systems supporting Java Runtime and C++ Compiler.

As indicated above, the visual programming system of the present invention finds utility in a wide variety of specialized applications. One such application is a process control environment of an electricity generating power plant. In this regard, the visual programming system of the present invention is used for implementing custom processing logic for process measurement, monitoring and improvement applications.

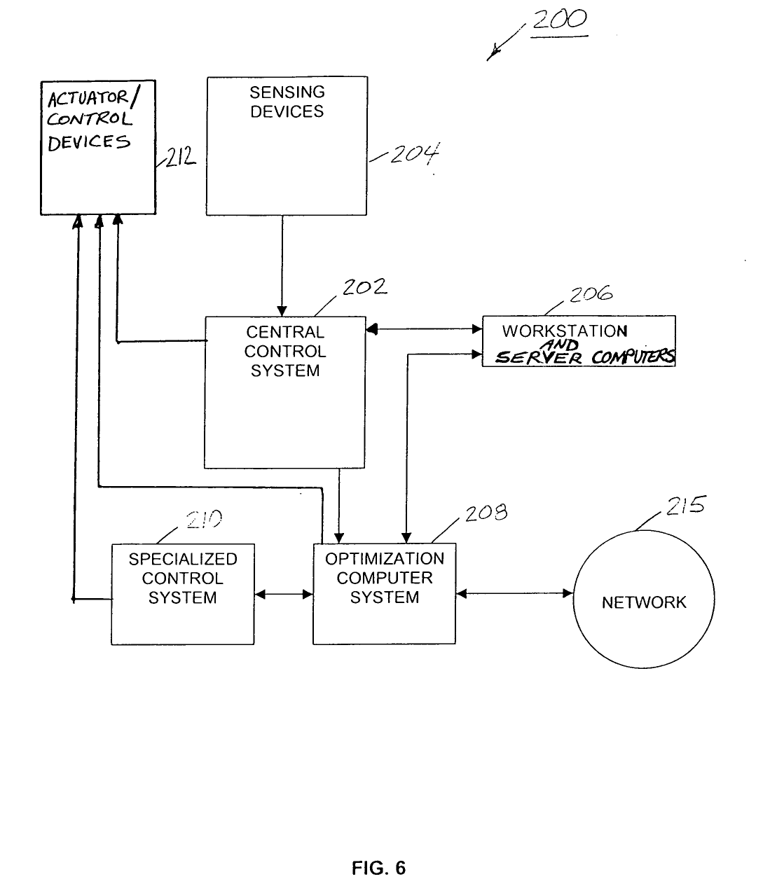

FIG. 6 shows a block diagram of an “exemplary” power plant control system 200. It should be appreciated that the block diagram shown in FIG. 6 is a simplification of control system 200, and is not intended to limit the scope of the present invention.

Control system 200 is generally comprised of a central control system 202, sensing devices 204, actuator/control devices 212, a plurality of workstation and server computers 206, at least one optimization computer system 208, and at least one specialized control system 210. It should be understood that data may be transferred between the elements of control system 200 via TCP/IP, or other data communications protocol.

Central control system 202 typically takes the form of a distributed or digital control system (DCS). Alternatively, central control system 202 may take the form of other types of control systems, including, but not limited to, an Analog Control System (ACS), a Programmable Logic Control (PLC) System, and the like. Central control system 202 receives data from sensing devices 204 that sense various operating conditions and parameters associated with the power plant. For instance, sensing devices 204 may include a continuous emissions monitoring system (CEMS) for sensing pollution emissions, temperature, pressure, flow, speed, magnitude, etc., as well as electricity consumption recorders and the like.

Optimization computer system 208 is generally comprised of one or more computer systems for generating plant process optimization data to improve process performance of various power plant sub-systems (e.g., combustion and sootblower sub-systems). In accordance with a preferred embodiment, the visual programming system of the present invention may be run on one or more optimization computer systems 208. Source code, executable code, or DLLs generated by the visual programming system is processed by optimization computer system 208 and sent to a respective specialized control system 210 for the purposes of advisory or supervisory closed-loop control actions.

Actuator/Control devices 212 (e.g., motors, drive mechanisms, dampers, valves, and the like) take the data generated by various control and optimization computer systems 202, 208 and 210, and perform the necessary actuation/control actions to influence the operation of power plant processes.

Specialized control system 210 is used to control one or more specific sub-systems in a power plant, such as a sootblower. Plant operators may use computers 206 to interface with central control system 202 and optimization computer system 208. In this regard, plant operators can access the visual programming system residing on optimization computer system 208 by directly using optimization computer system 208 and/or using computers 206. Computers 206 also preferably archive operating data to maintain a historical database.

It should be appreciated that a computer network 215 may be used to provide access to optimization computer system 208 from a remote computer.

As indicated above, optimization computer system 208 generates plant process optimization data to improve process performance of various power plant sub-systems, including, but not limited to, combustion and sootblower sub-systems. In this respect, optimization computer system 208 may support a “Sequential Optimizer” application, a “Combustion Optimization System” (COS) application, a Smart Sootblowing application, and an Intelligent Sootblowing application, all of which are explained in further detail below. It should be appreciated that optimization computer system 208 may support additional applications not disclosed herein.

The “Sequential Optimizer” application applies artificial intelligence technologies to improve performance and reduce emissions at power plants. Other technologies used are neural network based optimization, model predictive control, feedback control, etc. The “Sequential Optimizer” application is used to reduce the “Total Performance Loss” value associated with the power plant. The Total Performance Loss is defined by a calculation function that takes current process parameters as inputs, and generates a Total Performance Loss for the current process state. The Sequential Optimizer application “tunes” the process parameter to reduce the Total Performance Loss. The Total Performance Loss calculation changes for each power plant installation, since the Total Performance Loss calculation depends upon the process type and the business goals of the power plant. The Total Performance Loss calculation is also periodically updated as the power plant or business demand changes. The visual programming system of the present invention facilitates design and maintenance of the Total Performance Loss calculation function, as will be described in detail below.

The following function components are for use in connection with the “Sequential Optimizer” application: Applis, Attenuate, Bound, CP, CPK, CR, IPM, LAND, PLA, PLS, Round, and Roundf.

FIG. 20 illustrates a property window for defining the properties (i.e., application name and result name) associated with an Applis function component. The Applis function component checks if a given name is the application name. This function is used to make sure that the correct calculation DLL is used against the right application. This function takes two arguments, namely, the “application name” and the “result name.” The application name that is passed as an argument by the Applis function component is checked against the application name in the core of the “Sequential Optimizer” application. If the application names match, the result name variable is set to 1. Otherwise, the result name variable is set to 0. The application name that needs to be checked is entered in an “application name” field. The result of the check is stored in a user-defined variable that is entered in a “result name” field.

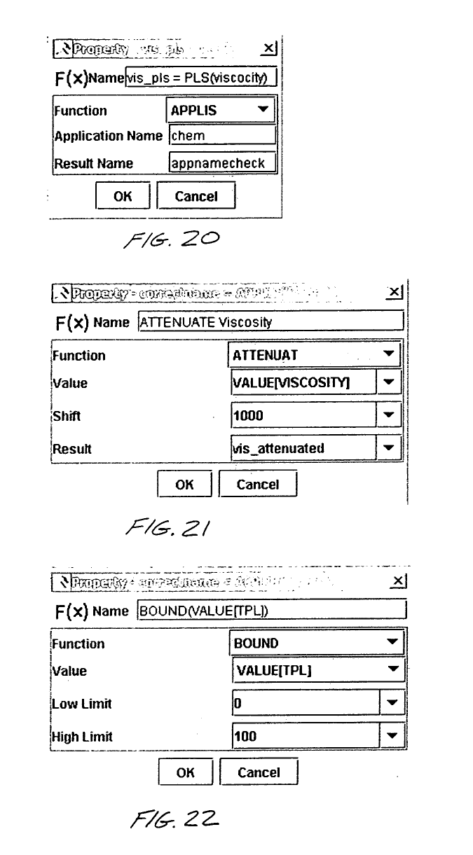

FIG. 21 illustrates a property window for defining the properties (i.e., value, shift, and result name) associated with an Attenuate function component. The Attenuate function is based on a blend of linear and logarithmic functions. As “value” exceeds “shift”, for a chosen parameter, the attenuation grows logarithmically. The value to be attenuated is entered in a “value” field. The threshold after which the attenuation starts is entered in a “shift” field. The result of the attenuation is stored in a user-defined variable that is entered in the “result” field.

FIG. 22 illustrates a property window for defining the properties (i.e., value, low limit, and a high limit) associated with a Bound Function component. The Bound function maps a “value” to the closest limit “lower threshold” or “higher threshold” if outside the limits. The variable to be mapped is entered in a “value” field. The lower threshold is entered in a “low limit” field, while the higher threshold is entered in a “high limit” field.

Other specialized function components are summarized as follows: a CP function calculates a Process Capability Value, a CPK function calculates the Process Capability Value CPK, a CR function calculates the Capability Ratio (1/CP), an IPM Function calculates correction factors and estimated results, a LAND function is a blend of linear and exponential function (i.e., as Value goes below SHIFT, it continues exponentially approaching zero asymptotically), a PLA function calculates the Performance Loss (Asymmetric) value, a PLS function calculates the Performance Loss (Symmetric) value, a Round function rounds Value to the closest multiple of UNITS, and a Roundf function rounds Value close to a fraction.

The “Combustion Optimization System” (COS) application is used to improve efficiency and decreases toxic gas emissions of electricity generating power plants. A “PERFIndex” program for calculating a performance index value, referred to as the “PERFIndex” value, is calculated to measure performance factors, including, but not limited to, boiler efficiency and unit heat-rate, that can be controlled by a plant operator or a COS. More specifically, the PERFIndex program calculates the relative increase/decrease of efficiency of boiler operation. The PERFIndex value represents the boiler related controllable losses, and can be used as a goal for a neural network based optimizing system. The PERFIndex value is a function of: delta dry gas loss, delta superheat temperature loss, delta reheat temperature loss, delta superheat at temperator spray loss, delta reheat at temperator spray loss, delta unburned carbon loss, and delta auxiliary power loss. The visual programming system of the present invention facilitates design and maintenance of the PERFIndex program, as will be described in detail below.

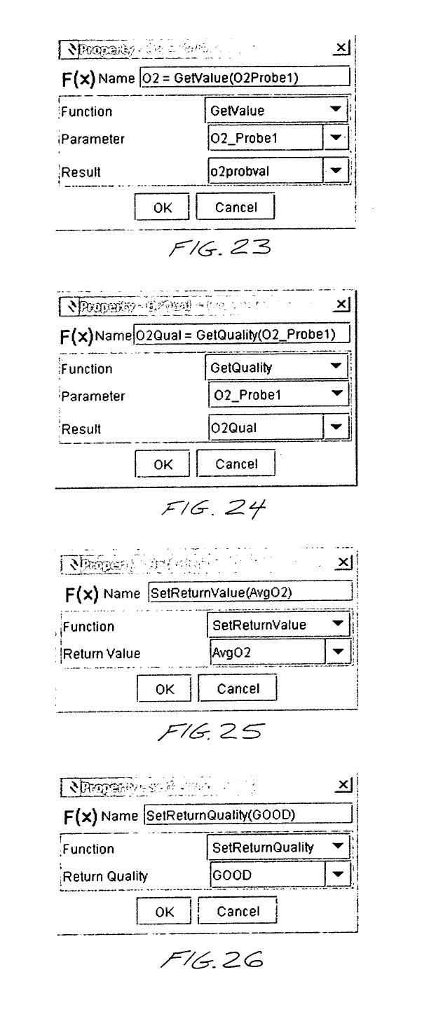

FIG. 23 illustrates a property window for defining the properties associated with a GetValue Function component. The GetValue Function gets the current value of the parameter identified in the “parameter” field. Parameters on central control system 202 are typically referred through a “tag name.” The GetValue Function takes the tag name as the parameter. The result name identifies where the current value will be stored.

FIG. 24 illustrates a property window for defining the properties associated with a GetQuality Function component. The GetQuality Function gets a “quality” attribute of the parameter identified in the “parameter” field. Quality attributes may be selected from the group consisting of the following attributes: “Good,” “Bad,” “Suspicious,” “Substituted,” etc. Each attribute is represented by a numeric value. The GetQuality Function takes the tag name (discussed above) as the parameter. The result name identifies where the numeric value representing a quality attribute will be stored.

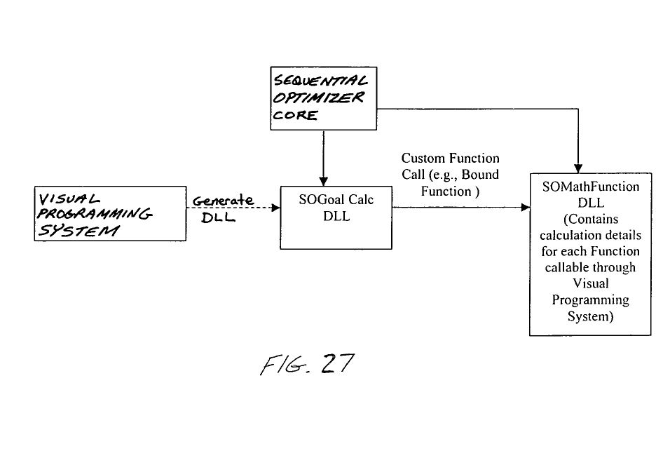

FIG. 25 illustrates a property window for defining the properties associated with a SetReturnValue Function component. The visual programming system of the present invention is used in connection with the PerfIndex application to calculate new “input values” based on current available input values. For example, an average O2 could be a new input created based on multiple O2 Probes input. The SetReturnValue Function sets the value for the new calculated input. This function takes a variable or a numeric constant as an argument, and sets the return value to the value of the variable or the numeric constant.

FIG. 26 illustrates a property window for defining the properties associated with a SetReturnQuality Function component. The SetReturnQuality function sets the quality attribute for a newly calculated input. This function takes a variable or a numeric constant as an argument, and sets quality attribute of the newly calculated input to the variable value. The numeric value should map to “GOOD,” “BAD,” “SUSPICIOUS,” “SUBSTITUTED,” etc. values defined in the PerfIndex application.

The use of the visual programming system to generate a DLL for use with the Sequential Optimizer application will now be described with reference to FIG. 27. The visual programming system of the present invention is used to develop a control flow sequence pertaining to the Sequential Optimizer application. The control flow sequence may include Function components customized for the Sequential Optimizer application, as discussed above. The Function components facilitates configuration of the arguments that need to be passed to the function call associated with Sequential Optimizer application at runtime.

As discussed in detail above, the visual programming system can generate source code (e.g., C or C++ source code) from the control flow sequence. It should be appreciated that the “function signature” is defined in the header region of the source code, and the “function call” is generated in the form of source code. The C, C++, etc. code treats the function as an external function that will be linked at runtime. Below is an example of how the source code might look like.

void BOUND(double, double, double);
void calc( )
{
...
Label10:
BOUND(value,10, 100);
...
}

The foregoing source code is compiled to produce a DLL called “SOGoalCalc DLL.” At Runtime, the SOGoalCalc DLL links with another DLL, “SOMathFunction,” which is part of the Sequential Optimizer application software. SOMathFunction DLL contains Sequential Optimization math functions associated with each function configurable through the visual programming system (e.g., the Bound Function). FIG. 27 illustrates how the function call from the “SOGoalCalc” DLL is passed to the “SOMathFunction” DLL at runtime.

The Smart and Intelligent Sootblowing applications are used to automate sootblower activation based on predefined events/conditions, bring about consistency in the sootblowing process, avoid unnecessary blowing at lower loads or under certain unit operating profiles, dynamically adjust sootblowing activities based on blowers in service, improve unit performance, reduce emissions, and notify appropriate personnel regarding abnormal operation or equipment failures. The Smart sootblowing application provides a control flow sequence-based system for improving boiler operation by consistently monitoring operational events and automating sootblowing activities. The control flow sequence-based system dynamically adjusts sootblower selection in a closed-loop supervisory control mode to automate the sootblowing activities thereby imposing consistency and improving plant performance. The Intelligent sootblowing application provides a neural network-based system for optimizing boiler operation by accommodating equipment performance changes due to wear and maintenance activities, adjusting to fluctuations in fuel quality, and improving operating flexibility. The neural network-based system dynamically adjusts combustion setpoints, bias settings and sootblower selection in a closed-loop supervisory control mode to simultaneously reduce NOx emissions, improve heat rate and fulfill other plant objectives.

The visual programming system of the present invention may be used in connection with a Smart or Intelligent Sootblowing application. In this regard, the visual programming system of the present invention may be used in a state space logic definition environment for real-time/dynamic retraining or retuning of neural-network based models. Expert Systems rely on a knowledge base to make expert decisions. The Knowledge base is a store of factual and heuristic knowledge. Typically, an expert updates the knowledge base frequently to keep the system updated. In a rule-based Expert System, the knowledge is a set of rules defined in a structure similar to “IF condition THEN action.” Accordingly, the Check IF component and other components of the visual programming system (i.e., Check Status component) can be conveniently used to define or update Expert System decisions logic.

Other modifications and alterations will occur to others upon their reading and understanding of the specification. While a preferred embodiment of the present invention has been described in connection with a power plant control application, it is contemplated that the present invention finds utility in a wide variety of specialized applications, including, but not limited, to manufacturing or production facilities utilizing control systems. It is also contemplated that the visual programming system of the present invention is suitable for use in connection with .NET framework. It is intended that all such modifications and alterations be included insofar as they come within the scope of the invention as claimed or the equivalents thereof

1. A visual programming system for generating custom processing logic, the system comprising:
means for selecting components from a group of components, wherein each component has associated properties, each selected component displayed in a design region;
means for defining the properties associated with each selected component;
means for linking the selected components to form one or more logic strings, said logic strings defining a control flow sequence;
means for generating from said control flow sequence at least one of: source code, executable code and a dynamically linked library (DLL); and
a global data store for storing data associated with each component of the control flow sequence, wherein each component of the control flow sequence shares their respective data with the other components through the global data store.

2. A visual programming system according to claim 1, wherein said group of components includes a component for generating a notification message.

3. A visual programming system according to claim 2, wherein said notification message includes the value of a variable in the control flow sequence.

4. A visual programming system according to claim 2, wherein said notification message is an electronic mail message sent to at least one electronic mail address.

5. A visual programming system according to claim 4, wherein said electronic mail message includes at least one file attachment.

6. A visual programming system according to claim 1, wherein data stored in said global data store is stored as a data object, each data object having an associated (a) data type field for identifying the type of data stored as the data object, (b) data name field for identifying a name for the data stored as the data object, and (c) reference count field for identifying the number of components that reference the associated data object.

7. A visual programming system according to claim 1, wherein said group of components includes at least one component for expert system decision logic.

8. A visual programming system according to claim 1, wherein said system further comprises means for examining the logic strings defining the control flow sequence, to map each component to a source code syntax and generate source code.

9. A visual programming system according to claim 8, wherein said system further comprises means for compiling the source code to generate at least one of executable code and a dynamically linked library (DLL).

10. A visual programming system according to claim 1, wherein said group of components includes at least one Function component, said Function component used in connection with at least one of: a Sequential Optimizer application, a Combustion Optimization System (COS) application, a PerfIndex application, a Smart Sootblowing application, and a Intelligent Sootblowing application.

11. A visual programming method for generating custom processing logic, the method comprising:
selecting components from a group of components, wherein each component has associated properties, each selected component displayed in a design region;
defining the properties associated with each selected component, wherein data associated with each component of the control flow sequence is stored in a global data store, each component of the control flow sequence sharing their respective data with the other components through the global data store;
linking the selected components to form one or more logic strings, said logic strings defining a control flow sequence; and
generating from said control flow sequence at least one of: source code, executable code and a dynamically linked library (DLL).

12. A visual programming method according to claim 11, wherein said group of components includes a component for generating a notification message.

13. A visual programming method according to claim 12, wherein said notification message includes the value of a variable in the control flow sequence.

14. A visual programming method according to claim 12, wherein said notification message is an electronic mail message sent to at least one electronic mail address.

15. A visual programming method according to claim 14, wherein said electronic mail message includes at least one file attachment.

16. A visual programming method according to claim 11, wherein data stored in said global data store is stored as a data object, each data object having an associated (a) data type field for identifying the type of data stored as the data object, (b) data name field for identifying a name for the data stored as the data object, and (c) reference count field for identifying the number of components that reference the associated data object.

17. A visual programming method according to claim 11, wherein said group of components includes at least one component for expert method decision logic.

18. A visual programming method according to claim 11, wherein said method further comprises the step of examining the logic strings defining the control flow sequence, to map each component to a source code syntax and generate source code.

19. A visual programming method according to claim 18, wherein said method further comprises the step of compiling the source code to generate at least one of executable code or a dynamically linked library (DLL).

20. A visual programming method according to claim 11, wherein said group of components includes at least one Function component, said Function component used in connection with at least one of: a Sequential Optimizer application, a Combustion Optimization System (COS) application, a PerfIndex application, a Smart Sootblowing application, and a Intelligent Sootblowing application.

21. A control system for an electricity generating power plant, comprising:
a central control system;
a plurality of sensing devices for sensing operating conditions and parameters associated with the power plant;
an optimization computer system for optimizing at least one power plant process; and
a visual programming system for programming the optimization computer system, said visual programming system comprising:
(a) means for selecting components from a group of components, wherein each component has associated properties, each selected component displayed in a design region,
(b) means for defining the properties associated with each selected component,
(c) means for linking the selected components to form one or more logic strings, said logic strings defining a control flow sequence,
(d) means for generating from said control flow sequence at least one of: source code, executable code and a dynamically linked library (DLL), and
(e) a global data store for storing data associated with each component of the control flow sequence, wherein each component of the control flow sequence shares their respective data with the other components through the global data store.

22. A control system according to claim 21, wherein said group of components includes a component for generating a notification message.

23. A control system according to claim 22, wherein said notification message includes the value of a variable in the control flow sequence.

24. A control system according to claim 22, wherein said notification message is an electronic mail message sent to at least one electronic mail address.

25. A control system according to claim 24, wherein said electronic mail message includes at least one file attachment.

26. A control system according to claim 23, wherein data stored in said global data store is stored as a data object, each data object having an associated (a) data type field for identifying the type of data stored as the data object, (b) data name field for identifying a name for the data stored as the data object, and (c) reference count field for identifying the number of components that reference the associated data object.

27. A control system according to claim 21, wherein said group of components includes at least one component for expert system decision logic.

28. A control system according to claim 21, wherein said system further comprises means for examining the logic strings defining the control flow sequence, to map each component to a source code syntax and generate source code.

29. A control system according to claim 27, wherein said system further comprises means for compiling the source code to generate at least one of: executable code and a dynamically linked library (DLL).

30. A control system according to claim 21, wherein said optimization computer system includes at least one of: a Sequential Optimizer application, a Combustion Optimization System (COS) application, a PerfIndex application, a Smart Sootblowing application, and a Intelligent Sootblowing application, said group of components includes at least one Function component, said Function component used in connection with at least one of: the Sequential Optimizer application, the Combustion Optimization System (COS) application, the PerfIndex application, the Smart Sootblowing application, and the Intelligent Sootblowing application.
